(19) United States
(12) Patent Application Publication
(10) Pub. No.: US 2021/0173874 A1
(43) Pub. Date: Jun. 10, 2021

(54) FEATURE AND CONTEXT BASED SEARCH RESULT GENERATION

(71) Applicant: Microsoft Technology Licensing, LLC, Redmond, WA (US)

(72) Inventors: Allison Giddings, Bellevue, WA (US); Mo Zhou, Medina, WA (US); Dong Yuan, Bellevue, WA (US); Tao Li, Bellevue, WA (US); Mayank Shrivastava, Redmond, WA (US); Emre Kok, Kirkland, WA (US); Hui Zhou, San Francisco, CA (US)

(73) Assignee: Microsoft Technology Licensing, LLC, Redmond, WA (US)

(21) Appl. No.: 16/703,420

(22) Filed: Dec. 4, 2019

(51) Int. Cl. G06F 16/903; G06N 20/00

(52) U.S. Cl. CPC G06F 16/90335; G06N 20/00

(57) ABSTRACT

In some examples, feature and context based search result generation may include identifying, based on analysis of a query feature associated with a query context of a query, and an entity feature associated with an entity context of each entity of a plurality of entities, a reduced number of entities that match the query. Based on analysis of a further query feature and a further entity feature, further matching analysis of the query to the reduced number of entities may be performed. The query may be linked by a linking model to an entity of the reduced number of entities to generate a query and entity pair. Selection of an entity may be received, and a linked plurality of queries and entities may be searched. In this regard, search results may be generated and include a set of queries that is associated with the selected entity.

### BACKGROUND

A user may perform a variety of types of searches using search engines, including web search engines. For example, a user may enter a query to perform a search for various types of information such as a company, a product, a process, etc. The query may include one or more words, numbers, characters, or a combination thereof. A search engine may implement various processes to generate search results for the query.

### BRIEF DESCRIPTION OF DRAWINGS

Features of the present disclosure are illustrated by way of example and not limited in the following figure(s), in which like numerals indicate like elements, in which:

FIG. 1 illustrates a layout of a feature and context based search result generation apparatus in accordance with an embodiment of the present disclosure;

FIG. 2 illustrates a logical flow to illustrate operation of the feature and context based search result generation apparatus of FIG. 1 in accordance with an embodiment of the present disclosure;

FIG. 3 illustrates a logical flow to illustrate a user behavior analysis of the feature and context based search result generation apparatus of FIG. 1 in accordance with an embodiment of the present disclosure;

FIG. 4 illustrates an example of rules for XYZ software to illustrate operation of the feature and context based search result generation apparatus of FIG. 1 in accordance with an embodiment of the present disclosure;

FIG. 5 illustrates a logical flow to illustrate an entity linking operation of the feature and context based search result generation apparatus of FIG. 1 in accordance with an embodiment of the present disclosure;

FIG. 6 illustrates a logical flow to illustrate category similarity determination for the feature and context based search result generation apparatus of FIG. 1 in accordance with an embodiment of the present disclosure;

FIG. 7 illustrates a logical flow to illustrate entity repository enrichment for the feature and context based search result generation apparatus of FIG. 1 in accordance with an embodiment of the present disclosure;

FIG. 8 illustrates an example of search results to illustrate operation of the feature and context based search result generation apparatus of FIG. 1 in accordance with an embodiment of the present disclosure;

FIGS. 9 and 10 illustrate metrics associated with the feature and context based search result generation apparatus of FIG. 1 in accordance with an embodiment of the present disclosure;

FIG. 11 illustrates an example block diagram for feature and context based search result generation in accordance with an embodiment of the present disclosure;

FIG. 12 illustrates a flowchart of an example method for feature and context based search result generation in accordance with an embodiment of the present disclosure; and

FIG. 13 illustrates a further example block diagram for feature and context based search result generation in accordance with another embodiment of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Feature and context based search result generation apparatuses, methods for feature and context based search result generation, and non-transitory computer readable media having stored thereon machine readable instructions to provide feature and context based search result generation are disclosed herein. The apparatuses, methods, and non-transitory computer readable media disclosed herein provide for linking of search queries with a plurality of entities. For example, the search queries may include on the order of hundreds of thousands or more queries per day, that may need to be linked to entities on the order of millions of entities. For the apparatuses, methods, and non-transitory computer readable media disclosed herein, once queries are linked to entities, a user may select an entity (e.g., company XYZ) of the linked entities from a repository. Search results may be generated and include search queries related to the selected entity. The search results that are generated as disclosed herein may be include a high accuracy, and may be generated in an efficient manner based on linking of queries to entities as disclosed herein.

With respect to the apparatuses, methods, and non-transitory computer readable media disclosed herein, given a search query such as “XYZ region men's jackets”, an example of linking of the search query with entities may include finding all of the relevant entities related to this search query. In this case, the entity, “XYZ Region Company” should be linked with the product line “XYZ region men's jackets” as specified in the query. However, since the term “XYZ region” may be considered ambiguous as it may represent a region or country, and may also be part of the entity “XYZ Region Company”, the query “XYZ region men's jackets” should not be linked to “XYZ region”. Thus, it is technically challenging to link queries to entities, and particularly, to ambiguous entities whose name or other information may not be directly related to contents of the query (e.g., where “XYZ region” represents a region or country, and “XYZ Region Company” represents the entity related to this search query). Moreover, for search queries that may include on the order of hundreds of thousands or more queries per day, that may need to be linked to entities on the order of millions of entities, it is technically challenging to generate accurate search results where an entity, such as an ambiguous entity, may be selected, and queries related to the entity are to be identified.

In order to address the aforementioned technical challenges, for the apparatuses, methods, and non-transitory computer readable media disclosed herein, a user may select an entity (e.g., “XYZ Region Company”) from a repository. Search results may be generated and include search queries related to the selected entity. In order to generate the search results, initially, search queries may be received. For example, the search queries may be received from a web search engine such as Bing™, or another type of search engine.

Query context associated the search queries, and entity context associated with entities, for example, in a repository may be obtained. For example, the query context as disclosed herein may include click information, Uniform Resource Locators (URLs), titles, and snippets, for example, from web engine data. The entity context as disclosed herein may include category, top URLs, top queries, alias, entity description, query context, named-entity recognition (NER) type, related entities, ambiguous score, and keywords with a score. Entities may include, for example, companies, products, brands, topics, or other such elements.

The dynamic and organized query context and entity context may be developed, for example, from user behavior on the web search engine. The dynamic query context and entity context may be used to generate candidate entities (e.g., a reduced number of entities as disclosed herein) for each query using keywords.

With respect to the reduced number of entities, features for each entity and query pair may be determined, and a similarity with respect to the features may be determined using the entity context and the query context. Each entity and query pair may then be scored using a machine learning model (e.g., the linking model as disclosed herein). For example, the machine learning model may include a tree model which uses the aforementioned features for each entity and query pair. According to examples disclosed herein, if an output score of the machine learning model is greater than or equal to a specified threshold (e.g., 0.5), for example, the entity and query pair may be assigned a positive label, and if the output score is less than the specified threshold, the entity and query pair may be assigned a negative label. As a final step, a global model may be used to generate a related entity stream by linking a parent entity (“XYZ Region Company”) if its child entity (“XYZ region style ABC jacket”) is scored as positive. In this manner, search queries may be linked to entities, and further, accurate search results may be generated where an entity, such as an ambiguous entity, may be selected, and queries related to the entity are to be identified.

With respect to the search results, a user may select an entity in a repository that they would like to see insights about. One of these insights may include spikes, new, and/or gradually rising search queries related to the entity. In this regard, query and entity linking as disclosed herein may be utilized to give more relevant results. Another type of insight may include an overall change in search query volume for the entity over time. Yet further, another type of insight may include attributes insight, which shows the commonly searched attributes for an entity.

For the apparatuses, methods, and non-transitory computer readable media disclosed herein embeddings, as disclosed herein, may be utilized to determine whether a search query is related to an entity. For example, search queries may be linked to entities to determine whether a company is more closely related to the query than a region.

For the apparatuses, methods, and non-transitory computer readable media disclosed herein NER, as disclosed herein, may be utilized to determine whether a company is an organization (e.g., ORG), a location (e.g., LOC), a person (PER), etc. This analysis may be used to determine whether or not an entity is more closely related to a query.

For the apparatuses, methods, and non-transitory computer readable media disclosed herein, queries may be linked to entities on a real-time basis. Alternatively or additionally, queries for a specified time period (e.g., all queries for a previous day) may be linked to entities in a repository.

For the apparatuses, methods, and non-transitory computer readable media disclosed herein, modules, as described herein, may be any combination of hardware and programming to implement the functionalities of the respective modules. In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

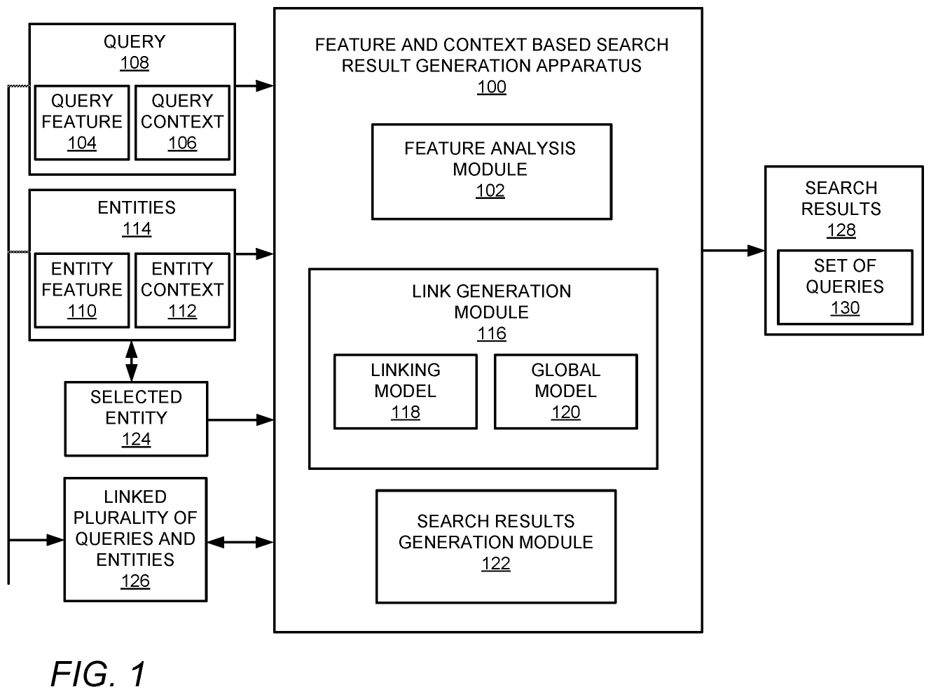

FIG. 1 illustrates a layout of an example feature and context based search result generation apparatus (hereinafter also referred to as “apparatus 100”).

Referring to FIG. 1, the apparatus 100 may include a feature analysis module 102 to identify, based on analysis of at least one query feature 104 associated with a query context 106 of a query 108, and at least one entity feature 110 associated with an entity context 112 of each entity of a plurality of entities 114, a reduced number of entities that match the query 108 from the plurality of entities 114.

A query feature may include, for example, a keyword included in a query, and an entity feature may include a keyword associated with an entity. A query context may include, for example, click information, URLs, titles, and snippets, for example, from web engine data. An entity context may include category, top URLs, top queries, alias, entity description, query context, NER type, related entities, ambiguous score, and keywords with a score.

The feature analysis module 102 may perform, based on analysis of at least one further query feature associated with the query context 106 of the query 108 and at least one further entity feature associated with the entity context 112 of the reduced number of entities, further matching analysis of the query 108 to the reduced number of entities.

The further query feature may include, for example, a domain associated with a URL, and/or an embedding associated with the query 108. The further entity feature may include, for example, a domain associated with a URL associated an entity and/or an embedding associated with an entity.

A link generation module 116 may link, based on analysis of results of the further matching analysis by a linking model 118, the query 108 to at least one entity of the reduced number of entities to generate at least one query and entity pair. A query and entity pair may include a query that may be linked (e.g., more closely related) to an entity, compared to other entities that are not in the query and entity pair.

According to examples disclosed herein, the link generation module 116 may link, for each entity of the at least one query and entity pair, a parent entity, if available, to a child entity. In this regard, the link generation module 116 may utilize a global model 120 as disclosed herein.

According to examples disclosed herein, the link generation module 116 may analyze, based on the analysis of the results of the further matching analysis by the linking model 118 that includes a tree model, the query 108 with respect to the reduced number of entities. Further, the link generation module 116 may generate, based on the analysis of the query 108 with respect to the reduced number of entities, an indication of linking of the query 108 to an entity of the reduced number of entities, or an indication of non-linking of the query 108 to the entity of the reduced number of entities.

The tree model may include a structure that receives as input a vector of similarity features. For each node in the tree model, a Boolean conditional may be used to determine which node should be traversed next, based on the values in the feature vector. A final node after traversal of intermediate node(s) may be a leaf node. A score output may be determined as the proportion of positive labels (e.g., from training data) that ended at the leaf node.

According to examples disclosed herein, the link generation module 116 may determine, based on the tree model, a score for each query and entity pair of the at least one query and entity pair. For example, as discussed above, the score may be determined as the proportion of positive labels (e.g., from training data) that ended at the leaf node. In this regard, based on a determination that the score is greater than or equal to a specified threshold (e.g., 0.5 as disclosed herein), the link generation module 116 may generate, for an associated query and entity pair, the indication of linking of the query to the entity of the reduced number of entities. Further, based on a determination that the score is less than the specified threshold, the link generation module 116 may generate, for the associated query and entity pair, the indication of non-linking of the query to the entity of the reduced number of entities.

According to examples disclosed herein, the link generation module 116 may determine, based on the tree model, a score for each query and entity pair of the at least one query and entity pair. In this regard, the link generation module 116 may modify, for each query and entity pair of the at least one query and entity pair, the score based on an ambiguity score of the entity of an associated query and entity pair. An ambiguity score may represent a measure of ambiguity associated with the entity.

According to examples disclosed herein, the link generation module 116 may identify, for the tree model, a rule to analyze each query and entity pair of the at least one query and entity pair. In this regard, the link generation module 116 may generate, based on the identified rule for each query and entity pair of the at least one query and entity pair, a score for each query and entity pair of the at least one query and entity pair.

According to examples disclosed herein, the link generation module 116 may determine, for each query and entity pair of the at least one query and entity pair, whether a clicked URL for the query includes entities that are not similar to the entity of the associated query and entity pair. In this regard, based on a determination, for each query and entity pair of the at least one query and entity pair, that the clicked URL for the query includes entities that are not similar to the entity of the associated query and entity pair, the link generation module 116 may generate an indication of a negative label for the entity of the associated query and entity pair. Alternatively, based on a determination, for each query and entity pair of the at least one query and entity pair, that the clicked URL for the query includes the entity of the associated query and entity pair, the link generation module 116 may generate an indication of a positive label for the entity of the associated query and entity pair. Further, the link generation module 116 may utilize, based on the tree model and for each query and entity pair of the at least one query and entity pair, the negative label or the positive label for the entity of the associated query and entity pair, to determine a score for each query and entity pair of the at least one query and entity pair.

A search results generation module 122 may receive selection of an entity (e.g., a selected entity 124) of the plurality of entities 114.

The search results generation module 122 may search, based on the selected entity 124, a linked plurality of queries and entities 126 that include the query linked to the at least one entity of the reduced number of entities.

The search results generation module 122 may generate, based on the search of the linked plurality of queries and entities 126, search results 128 that include a set of queries 130 from a linked plurality of queries that is associated with the selected entity. In this regard, according to examples disclosed herein, the search results may include the parent entity, if available, linked to the child entity for each entity of the at least one query and entity pair.

According to examples disclosed herein, the set of queries 130 may include a specified number of queries that are associated with the selected entity 124.

According to examples disclosed herein, the at least one query feature 104 associated with the query context 106 of the query 108 includes at least one keyword included in the query. In this regard, the at least one entity feature 110 associated with the entity context 112 of each entity of the plurality of entities 114 may include at least one keyword associated with each entity of the plurality of entities 114. As disclosed herein, the at least one keyword included in the query may be obtained directly from the query, and the at least one keyword associated with each entity of the plurality of entities 114 may be specified for the entity.

According to examples disclosed herein, the link generation module 116 may specify, based on analysis by a rule, inclusion, with respect to each entity of the plurality of entities, of the at least one keyword associated with each entity of the plurality of entities based on utilization of the at least one keyword associated with each entity of the plurality of entities in queries associated with each entity of the plurality of entities.

According to examples disclosed herein, the at least one further query feature associated with the query context 106 of the query 108 may include a domain associated with a Uniform Resource Locator (URL) associated with the query 108. In this regard, the at least one further entity feature associated with the entity context 112 of the reduced number of entities may include a domain associated with a URL associated with the reduced number of entities.

According to examples disclosed herein, the at least one further query feature associated with the query context 106 of the query 108 may include an embedding associated with the query 108. In this regard, the at least one further entity feature associated with the entity context 112 of the reduced number of entities may include an embedding associated with the reduced number of entities. An embedding may represent a vector of numbers representing a semantic understanding of the context (e.g., the query context 106 or the entity context 112).

Operation of the apparatus 100 is described in further detail with reference to FIGS. 1-10.

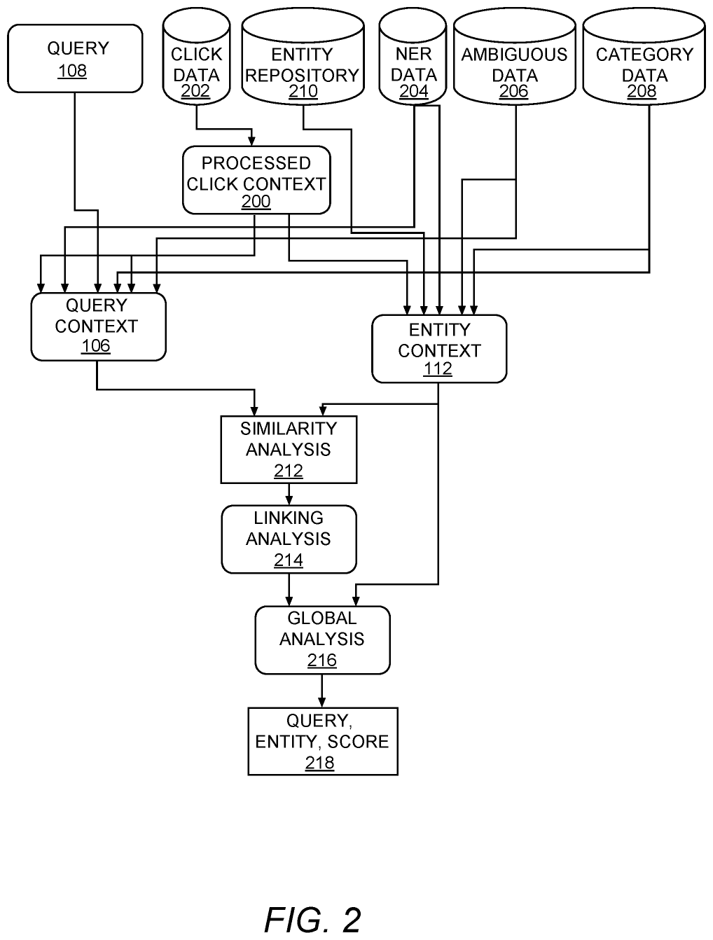

FIG. 2 illustrates a logical flow to illustrate operation of the apparatus 100 in accordance with an embodiment of the present disclosure.

Referring to FIG. 2, for the query 108, the query context 106 may include information from processed click context 200 based on click data 202, NER data 204 (e.g., whether the query is associated with a person (PER), a location (LOC), an organization (ORG), or other), ambiguous data 206, and category data 208. Click context may represent an aggregated view of click data, where the query and URL are aggregated and a count for the number of times that URL as clicked from that query is included. Then query and URL similarity may be determined based on their percent of overlapping URLs (for query similarity) and queries (for URL similarity). Click data may include the query, and URL clicked on from the query with its title and snippet for each individual click. The ambiguous data may include a common word lookup, disambiguation flag such as a WIKI™ disambiguation flag, an aggregate of these two metrics, and the precision, recall, F1 score, and rule score of the keyword. Category data may be a category that the query or entity is in, for example, software, retail, or healthcare.

The entity context 112 may include the processed click context 200 based on click data 202, entity information from an entity repository 210, the NER data 204, the ambiguous data 206, and the category data 208. The click context for an entity may be based on the same context described for the query, but with the entity (for example, top five URLs and top five queries may lead to the entity). Then the click context may be aggregated across these top five URLs and queries as an average. The NER data for an entity may be based on the same data described for the query, but for the entity. The ambiguous data may be based on a keyword, which is part of the entity context and the query context, since the keyword is part of the entity and may also appear in the query. Category data for an entity may be based on the same data described for the query, but for the entity.

At block 212, the feature analysis module 102 may perform a similarity analysis with respect to the query context 106 and the entity context 112. In this regard, the feature analysis module 102 may perform, based on analysis of at least one further query feature associated with the query context 106 of the query 108 and at least one further entity feature associated with the entity context 112 of the reduced number of entities, further matching analysis that includes a similarity analysis of the query 108 to the reduced number of entities.

With respect to the similarity analysis performed at block 212, keywords (e.g., including those with low precision) may be used to identify candidate entities for the query 108. Thereafter, features representing different aspects of the similarity between the query 108 and each entity of the reduced number of entities may be determined. For example, the feature analysis module 102 may analyze click similarity features that provide for an indication of the similarity between the query 108 and its URL (or URLs) with the URLs associated with each entity of the reduced number of entities. The similarity analysis between the query 108 and its URL (or URLs) with the URLs associated with each entity of the reduced number of entities may be determined by calculating the overlapping queries from the two URLs as a weighted score, where the weight is the number of clicks leading from a query to a URL. The feature analysis module 102 may analyze features related to the similarity of the domains of these URLs for linking the query 108 to one or more entities of the reduced number of entities. The feature analysis module 102 may generate a weighted score for the queries leading to the domains of the two URLs, and another score for the aggregate of all URLs with that domain.

With respect to the similarity analysis performed at block 212, the feature analysis module 102 may analyze features related to the score of and type of the keywords used to match the query 108 with an entity of the reduced number of entities. The score may be based on the precision and recall of a keyword, which may be determined using the entity top queries. Types of keywords may include name, alias, navigational query, and ngram. The feature analysis module 102 may determine the probability of an entity given a keyword, the precision and recall based on weighted query similarity, and Artificial General Intelligence (AGI) similarity between the entity name and keyword. The AGI may represent an embedding based on web search data.

With respect to the similarity analysis performed at block 212, the feature analysis module 102 may analyze ICE category similarity between an entity category and the query, title, snippet, and URL ICE category with respect to the query 108. ICE may represent a model trained to assign a category given some short text. The category similarity may represent the AGI cosine similarity (embedding) between an entity category and the query, title, and snippet. A snippet may represent short text describing a web search page to give users more context if they should click the title to go to the web page. The cosine similarity of the AGI embedding vectors may result in a score between 0 and 1.

With respect to the similarity analysis performed at block 212, the feature analysis module 102 may analyze features based on textual similarity between the query 108 and entity name, alias, and top query for an entity.

With respect to the similarity analysis performed at block 212, the feature analysis module 102 may utilize NER to compare the type (LOC, ORG, PER, OTHER) of the query 108 and the entity name.

With respect to the similarity analysis performed at block 212, the feature analysis module 102 may utilize words from the snippet and URL of the query 108, and compare this information to words identified in the entity name, entity alias, and related entities to a candidate entity. An entity alias may represent an alternative name for an entity. With respect to the similarity analysis, the feature analysis module 102 may determine a sum of a number of times the entity, and separately the entity alias, appear separately in the title and snippet.

With respect to the similarity analysis performed at block 212, the feature analysis module 102 may determine and utilize a trained embedding for the entities 114. In this regard, each entity may include, for example, four embeddings trained on different context that includes links, such as WIKI™ links, anchor, such as WIKITM anchor, description, such as WIKITM description, and query context. An anchor may represent the source and destination of a web link. For the query 108, the feature analysis module 102 may determine the embedding for the query 108, an associated title, and an associated snippet. The feature analysis module 102 may determine the embedding similarity, and add the embedding similarity as a feature for the different contexts. In this regard, the feature analysis module 102 may compare the embeddings using a cosine similarity of the two vectors, resulting in a score between 0 and 1.

With respect to the similarity analysis performed at block 212, as disclosed herein, the feature analysis module 102 may also analyze features for measuring the ambiguity of the query 108 with respect to the reduced number of entities. Thus, as disclosed herein, the feature analysis module 102 may learn different features for the ambiguous pairs of queries and entities, and then for non-ambiguous pairs of queries and entities.

At block 214, as disclosed herein, the link generation module 116 may link, based on analysis of results of the further matching analysis by the linking model 118, the query 108 to at least one entity of the reduced number of entities to generate at least one query and entity pair. In this regard, the link generation module 116 may generate, based on the analysis of the query 108 with respect to the reduced number of entities, an indication of linking of the query 108 to an entity of the reduced number of entities, or an indication of non-linking of the query 108 to the entity of the reduced number of entities.

With respect to block 214, the link generation module 116 may utilize the linking model 118 to predict a positive (linked) or negative (not linked) prediction. The input to the linking model 118 may be a vector with the similarity features included as disclosed herein. For each node in the tree model, one or more values may be passed through a Boolean conditional. From there, the left or right node may be traversed in the tree model, based on the values in the feature vector. A final node for the tree model may include a leaf node. The score in this regard may be the proportion of positive labels (from the training data) that ended at that leaf node. The linking model 118 may be built utilizing a set of training query and entity pairs. The testing data may be divided into head, tail, common (body), ambiguous, and competition-related query sets. The head, tail, and common (body) query sets may be related to how popular the query is, that is, how many users have issued this query (e.g., head being more popular queries and tail being less popular queries). In this regard, results generated based on utilization of the linking model 118 may include higher accuracy of query and entity matching.

At block 216, as disclosed herein, with respect to the global model 120, the link generation module 116 may link, for each entity of the at least one query and entity pair, a parent entity, if available, to a child entity. For example, the global model 120 may be built as a hierarchy using, for example, name and domain features, and company-product relationships. For example, an “XYZ region men's clothing” entity may be linked to an “XYZ region men's jackets” query, but “XYZ Region Company” may not initially be linked due to underperforming features. However, since the “XYZ Region Company” is a parent entity, it may also be linked based on the global model. The global model 120 may also be used to improve the precision for ambiguous queries. For example, utilization of the global model 120 may directly improve the positive recall, which consequently will also improve the positive precision. In this regard, an increase in the number of true positives will increase the positive precision and positive recall.

At block 218, results based on utilization of the linking model 118 and the global model 120 may be combined to determine the probability of a keyword given an entity for the entities 114 and relevant keywords. Query-entity pairs with a high probability keyword may be brought up while those with a lower probability keyword may be brought down. In this regard, since a rule score is based on the keyword probability, updating the rule score may directly bring up or lower the overall linking probability. For example, the entity “ABC team” may be linked with many queries containing basketball, while “XYZ team” may be linked with many queries containing baseball. In this regard, the global model 120 may remove queries from “XYZ team” which contain basketball while keeping queries that include baseball.

With respect to block 218, other elements such as scores related to query and entity pairs may be generated as disclosed herein with respect to operation of the link generation module 116.

Referring again to FIG. 1, with respect to the entities 114 analyzed by the feature analysis module 102, a structure of each entity may be specified with respect to facts, behavior based on user clicks, and relationships.

With respect to facts, an entity may include factual information such as an entity identification that uniquely identifies the entity, an entity name, and an entity official URL (e.g., a web page or company official site).

With respect to behavior based on user clicks, an entity may include entity top queries, entity top URLs, and entity category. With respect to entity top queries, based on user click behavior in a web search engine, the top queries of an entity may be changed to reflect the query topics talking about the entity. The click behavior may be described as behavior that includes a user search for a query and then clicking on a web page. With respect to entity top URLs, based on user clicked URLs in a web search engine, the top URLs of an entity may be changed to reflect the documents that refer to the entity. Further, with respect to entity category, in order to classify entities into categories, entity top queries (e.g., top queries for an entity) and top URLs based on user clicks may be analyzed. For example, the most representative clicks may be selected, and thus the most representative user behavior may be logged. Based on representative user behavior, text from the query, URL's title, and snippet may be obtained to determine the associated category. In this regard, the query has URLs clicked on after a user searched that query, and every URL also has a title and a snippet. This text may be joined together and input into the ICE model to obtain the category.

With respect to relationships, the entity structure may be separated into competition and company-product. With respect to competition, based on user search behavior, two entities may be identified as including a competing or non-competing relationship. For example, when user behavior changes, the competition relationship may also change. For example, two competing companies may no longer be in a competing relationship after a merger. With respect to company-product, based on search queries, a relationship of whether an entity is a product or not and whether the product belongs to the company or not may be identified. Both competitors and product relationships may be aggregated into a related entity stream. Features may be determined as the sum of the number of times the related entities appear in the query, and titles and snippets from URLs clicked form the query.

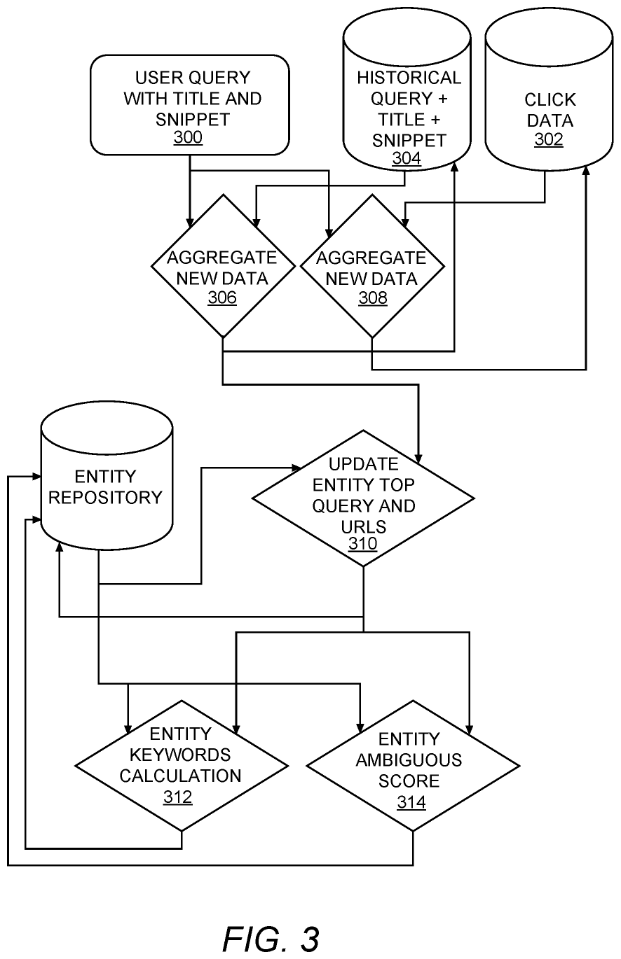

FIG. 3 illustrates a logical flow to illustrate a user behavior analysis of the apparatus 100 in accordance with an embodiment of the present disclosure.

Referring to FIG. 3, with respect to queries, such as the query 108, queries analyzed by the feature analysis module 102 may account for user behavior. For example, the search results 128 may change based on user behavior associated with the query 108. User behavior, such as searching on a web search engine and clicking a document (e.g., at 300 and 302), may directly update data associated with the query 108 with title and snippet (e.g., at 304), and/or query and URL information. The feature analysis module 102 may utilize the updated data (e.g., at 306 and 308) to update entity meta data streams (e.g., at 310) that include entity top queries and top URLs, entity matching rules, entity relationships (e.g., parent and child relationships), and entity category. The feature analysis module 102 may utilize entity meta data streams to update entity linking specific data such as entity keywords with score (e.g., at 312) and/or entity ambiguous score by keyword (e.g., at 314). Entity keywords with score data may be determined based on entity keyword probability, AGI similarity of entity name and keyword, and precision/recall calculations based on the entity top queries. The ambiguity of a keyword may be described by its precision, recall, and F1 metrics based on the entity top queries. Each query may be weighted by its counts for the entity (user click counts), and thus a keyword may be more ambiguous (e.g., lower precision) if it leads to top queries for many entities.

Referring again to FIG. 1, with respect to entity rules with keywords, inclusion and exclusion, if user behavior changes, a rule may change as well. For example, people may search for “XYZ” for “XYZ company”, and the rule for “XYZ company” may include a keyword “XYZ”. Once a significant number of users are identified as searching for “XYZ fire United States”, the rule for “XYZ company” may be changed to keyword: “XYZ”, exclusion: “United States”.

With respect to entity rules with keywords, inclusion and exclusion, training data may be obtained from user clicks (e.g., behavior data). In this regard, as disclosed herein, the link generation module 116 may determine, for each query and entity pair of the at least one query and entity pair, whether a clicked URL for the query includes entities that are not similar to the entity of the associated query and entity pair. In this regard, based on a determination, for each query and entity pair of the at least one query and entity pair, that the clicked URL for the query includes entities that are not similar to the entity of the associated query and entity pair, the link generation module 116 may generate an indication of a negative label for the entity of the associated query and entity pair. Alternatively, based on a determination, for each query and entity pair of the at least one query and entity pair, that the clicked URL for the query includes the entity of the associated query and entity pair, the link generation module 116 may generate an indication of a positive label for the entity of the associated query and entity pair. For example, for each query, the link generation module 116 may determine the clicked URLs for the query. If a clicked URL includes multiple entities and the entities are not similar to a target entity, the link generation module 116 may consider the query has a negative label for the entity. In this regard, if the clicked URL contains the target entity, the link generation module 116 may assign a positive label to the query.

With respect to entity rules with keywords, inclusion and exclusion, the feature analysis module 102 may determine a rule score from labeled data. The rule score may reflect the user behavior. Thus, the rule score may be determined for multiple rules for a single entity, with keywords, inclusions, exclusions, and intelligent relevance scoring.

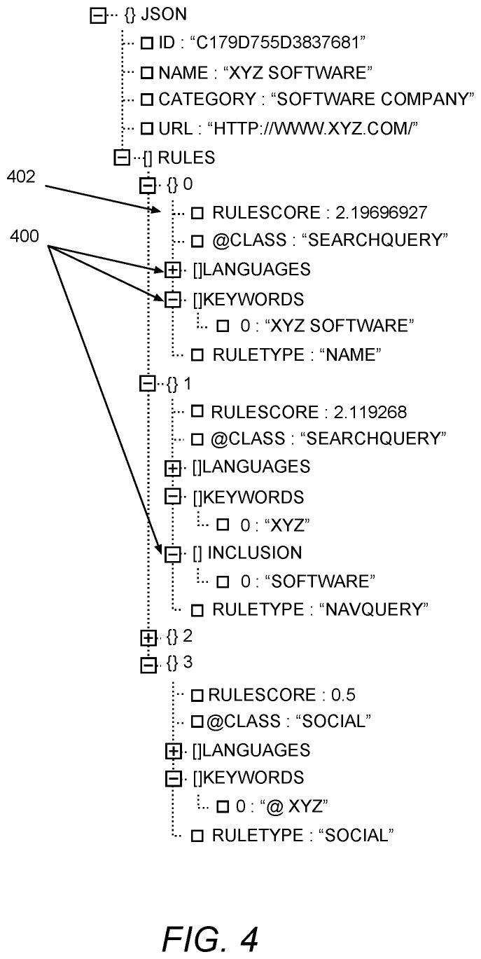

FIG. 4 illustrates an example of rules for XYZ software to illustrate operation of the apparatus 100 in accordance with an embodiment of the present disclosure.

Referring to FIG. 4, with respect to entity rules with keywords, inclusion, and exclusion, different types of rules may be specified and scored. For example, for MNO software, different types of rules may include rules related to languages, keywords, inclusion, etc. (e.g., at 400). In FIG. 4, the element @Class may be related to the source of the keyword. Languages may indicate what markets the keyword may be used for. Rule type may be related to how the keyword related to the entity. Further, inclusion may represent additional keywords that when included with the main keyword are a very strong indicator the entity and query are linked. The rules may be scored as shown at 402.

In order to utilize the rules with the entities 114, the link generation module 116 may implement rule selection and rule scoring as follows.

With respect to rule selection, a goal of rule selection may include mining all of the queries leading to an entity. For example, queries leading to “XYZ”, may include “XYZ Company”, “XYZ stock”, “XYZ news”, etc. In this regard, the link generation module 116 may distinguish the positive and negative queries for each entity. For example, the queries “XYZ news” and “XYZ stock” may represent positive queries for “XYZ Company”. However, “XYZ clothes”, or “XYZ travel” may be treated as negative queries for “XYZ Company”. Based on the foregoing, the link generation module 116 may determine the top leading keywords, or keywords and inclusion and exclusion pairs as rule candidates. The keyword candidates may be generated as unigrams from the entity top queries.

With respect to rule scoring, the link generation module 116 may implement rule scoring to achieve high accuracy search results. In this regard, precision and recall measurements as disclosed herein may be used to measure precision with respect to rules, and how many queries each rule can match. Based on the rule scoring, the link generation module 116 may implement rule selection and ranking to balance the precision and recall. With regard to balancing of precision and recall, keywords should have good precision and good recall, rather than just very good precision with low recall or very good recall with low precision. In the rule scoring, both precision and recall may be considered for a fair rule score. In the rule selection, the thresholds for both precision and recall may be utilized to perform rule selection. Thus, rules that meet the precision and recall specification may be treated as acceptable rules.

With respect to the rules, rule selection may be based on AGI similarity (name, keyword), probability for the entity given a keyword, and precision and recall. For example, for AGI similarity (name, keyword), an assumption is that “name” is the best rule. The selected rules may need to be similar to the name rule. Further, the rule selection may be relayed on query clicking. With respect to probability for the entity given each of the keywords, this probability may be represented as P(E|K). With respect to precision and recall, precision and recall may be represented as follows:

$$\begin{matrix}Precision ( r ) = \frac{{\sum }_{q ∈ {Q}_{r}} \{ Weight ( q ) * {\sum }_{eq ∈ EQ} ( Similarity ( eq , q ) * Ratio ( eq ) ) \}}{{Σ}_{q ∈ {Q}_{r}} Weight ( q )} & Equation ( 1 ) \\ Recall ( r ) = \frac{{\sum }_{q ∈ {Q}_{r}} \{ Weight ( q ) * {\sum }_{eq ∈ EQ} ( Similarity ( eq , q ) * Ratio ( eq ) ) \}}{{\sum }_{r ∈ R} {\sum }_{q ∈ {Q}_{r}} \{ Weight ( q ) * {\sum }_{eq ∈ EQ} ( Similarity ( eq , q ) * Ratio ( eq ) ) \}} & Equation ( 2 )\end{matrix}$$

For Equations (1) and (2), r may represent each rule candidate only for all rules R, eq may represent each query in top queries EQ for the entity, Similarity(eq, q) may represent query-URL click data based similarity from click data, q may represent one query matched by the target rule, weight(q) may represent the search frequency on a web search engine, Qᵣ may represent query repository, and Ratio(eq) may represent the weight ratio for each top query across entity top queries.

With respect to the rules, rule scoring may be based on balancing on similarity, precision and recall. In this regard, scoring may be tuned based on examination of a sample set of entities. The score may be thus determined as follows:

Score=αF1+βSimilarity+γPrecision Equation (3)

For Equation (3), a may represent the weight of the F1 measure (2*Precision*Recall/(Precision +Recall)), β may represent the weight of the similarity measure, and y may represent the weight of the recall measure. In total, α+β+γ=1. The tree models may leverage this as input together with other features to perform a probability prediction. This score may represent a statistic based score without machine learning models. These three weights may provide a flexible technique of adjusting the different weight of measurements on different perspectives of precision, recall and F1.

With respect to selection balancing precision and recall, selection balancing precision and recall may be performed as follows:

(Precision >0.8*Precision_Max && Recall >0.01)

(Precision >0.75*Precision_Max && AGISimilarity >0.65 && Recall>0.01)

(AGISimilarity >0.8 && Recall >0.4 && Precision >0.4*Precision_Max)

(AGISimilarity >0.7 && Precision >0.6*Precision_Max && Recall>0.15)

(AGISimilarity >0.85 && Recall >0.05 && Precision >0.1)

(AGISimilarity >0.90 && F1==0.0) IIRanking ==1

Ranking(Score DESC) ==1

These complex rule selections may provide for balancing of precision, recall and the F1 score for selection of the best top rules. All of these numbers or weights may be analyzed based on rule scoring statistics. For example, the rule “Precision >0.8*Precision_Max && Recall >0.01” may be utilized to maintain high precision first and then consider recall, for example, to help retain the entity specified rule which may be accurate on precision, but may not cover too many queries. The rule “Precision >0.75*Precision_Max && AGISimilarity >0.65 && Recall >0.01” may include a slightly lower precision, but includes AGI similarity added as a backup threshold to maintain data quality on precision or accuracy. The rule “AGISimilarity >0.90 && F1==0.0) ∥Ranking ==1”, may include a first goal that if not enough data is available to compute the precision and recall, and F1, AGI similarity may be used to keep a high similarity rule, and in a worst case, the best rule may be kept while making sure that there is one rule per entity at a minimum.

Thus, with respect to rule selection, the link generation module 116 may determine the probability of an entity given each of the keywords (P(E|K)) based on the query similarity. In this regard, the names rules may be considered as the best rules, and accordingly, the link generation module 116 may determine the similarity between names rules matched queries to target rule matched queries. For each target rule matched query, the link generation module 116 may determine a similarity score voting by all of the queries from name rule matched queries which were treated as a baseline. If the similarity is higher, the link generation module 116 may treat this as TRUE positive, else, the link generation module 116 may treat this as FALSE positive. For the precision and recall Equations (1) and (2), the link generation module 116 may consider the similarity of each query matched by the target rule together with the query weight to determine a weighted precision which represents how many queries matched by the rule are correct, or a weighted recall which represents how many correct queries can be matched by this rule. Based on the precision and recall, the link generation module 116 may determine the F1 score, which may be represented as 2*(precision * recall)/(precision +recall), considering both precision and recall. Furthermore, the link generation module 116 may utilize linear regression to account for the F1 score, similarity, and precision, to thus represent the rule score and to perform rule selection.

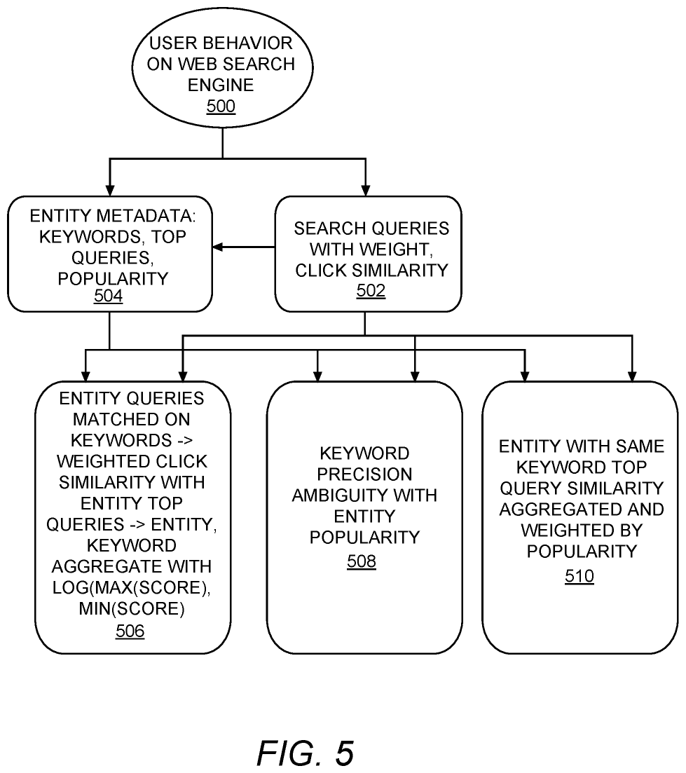

FIG. 5 illustrates a logical flow to illustrate an entity linking operation of the apparatus 100 in accordance with an embodiment of the present disclosure.

With reference to FIG. 5, keywords, as utilized by the feature analysis module 102 may improve the efficiency of entity linking by limiting the number of entity candidates that need to be considered for each query. The utilization of keywords may also improve the precision of the linking model 118 by providing a score for each entity and keyword pair. The utilization of keywords may also improve the recall of the linking model 118 by adding keywords that do not overlap with the entity name.

For example, for the entity “PQR” and the query “PQ login”, without the use of keywords, the feature analysis module 102 may attempt to link the entity “PQR” and the query “PQ login” if a comparison is performed for every entity with the query 108. If words in the entity name are compared with the query, the entity “PQR” and the query “PQ login” will not be matched. However, based on the inclusion of “PQ” as a keyword for the entity “PQR”, the entity repository may be organized with keywords. In this regard, the “PQ” keyword for the entity “PQR” may be directly matched with “PQ” in “PQ login”. Further, entities that do not include keywords “PQ” or “login” may be ignored. Thus, adding keywords results in improved performance of the feature analysis module 102, and thus improved accuracy of the search results 128.

With respect to enrichment of entities with an ambiguity score, entity linking may be technically challenging due to ambiguity in the entity and/or query. In this regard, as disclosed herein, the link generation module 116 may determine an ambiguity score of an entity of an associated query and entity pair. For example, adding a score for the ambiguity of an entity, or an entity and query pair, may improve the performance of the link generation module 116. For example, knowledge of the ambiguity of an entity may enable the link generation module 116 to learn to require ambiguous terms to include higher scores from other features, while if the entity is not ambiguous a lower threshold may be utilized. With respect to utilization of the higher scores and the lower threshold, the structure of a tree model may allow the input feature vector to divide the data so that ambiguous queries follow one path of the tree while non-ambiguous queries follow another path. In this manner, for two input vectors with the same feature values but with different ambiguity features, the one that is less ambiguous may result in a higher score than the one that is more ambiguous. Thus, inclusion of the ambiguity score may improve the precision of results generated by the link generation module 116 for ambiguous entities and the recall for unambiguous entities. For example, since unambiguous entities are unlikely to be paired with the wrong candidate, less high feature values may be needed to link to the unambiguous entities, and thus performing this division of data increases the recall. Then, this division of the data may require higher feature values for the ambiguous entities. Thus, the score may be determined from the keywords ambiguity, related to the rule scoring as disclosed herein, and then a Boolean condition in the tree may divide the ambiguous and unambiguous inputs.

With respect to an analysis of whether an entity is ambiguous, and measurement of this ambiguity, an entity and query pair may be ambiguous if the keyword used to match them is a common English word, and a keyword can be disambiguated. This approach may result in a true/false result, but may not capture the full complexity of how ambiguous a term is. Thus, the link generation module 116 may utilize a combination of keyword to entity ambiguity, keyword ambiguity, and entity ambiguity.

The feature analysis module 102 may identify queries that include a keyword for the entity. The analysis by the feature analysis module 102 may result in data with the entity identification (ID), name, query, keyword, keyword precision, and query weight. A query weight may represent the number of times a user searched that query compared to other queries. For the aforementioned reduced number of entities that match the query 108 from the plurality of entities 114, the feature analysis module 102 may compare the click similarity for these entities with the queries they were matched through ambiguity keywords. With respect to user behavior at 500 of FIG. 5, click similarity may be determined at 502 from the user behavior (e.g., when a user searches a query on a web search engine, an analysis may be made as to what the user clicks on, and compared to a different query a user searched for on the web search engine). If a user's behavior changes what is being clicked, the weights for the click behavior may be updated. In this regard, as disclosed herein, for a query, associated factors may include a weight (e.g., number of searches), URL, URL weight (e.g., number of clicks), title, and snippet of URL, and the click behavior may include a number of times a URL was clicked after searching a query.

Based on the identification of the search queries with weight, and click similarity at 502, at 504, entity metadata may be determined. The entity metadata may include top queries, and popularity associated with each entity. Popularity of the entity may represent an aggregate of the query weight for the entity top queries.

At 506, the link generation module 116 may determine a weighted similarity based on the entity query weight. The link generation module 116 may identify queries with keywords that were matched with multiple entities. If the entity and query weighted similarity is represented as P1, this similarity may be scored as follows:

P1*Math.Log(Max(P1, P2)/Min(P1,P2)) Equation (4)

For Equation (4), P2 may represent the entity and query weighted similarity for another entity. For a given entity in P1, the entity P2 may be an entity which has a keyword in common with P1. These scores may be aggregated by keyword. For example, these scores may be aggregated for all entities which share some keyword with P1. Then score for Equation (4) may be combined with the following Equations (5) and (6) as an ambiguous score (0 to 1) for utilization by the link generation module 116.

At 508, the keywords from the entities may be aggregated since some keywords may be used for multiple entities. Since the keywords are also updated based on user behavior, this score may also be updated as follows:

Math.log(Popularity)*(1-Precision)\hat{ }2 Equation (5)

For Equation (5), the popularity may be utilized for the entity and the precision may be utilized for the keyword. The score for Equation (5) may be used with Equation (6) to determine the ambiguous score, which is an input to the tree model.

At 510, the link generation module 116 may determine a weighted similarity aggregate by keywords. The weights may be determined from the entity popularity. The entity popularity may be based on the aggregate weight of its top queries. The entity popularity may be based on a query popularity relevant to the entity, and thus may be dynamic and updated. In this regard, if an entity is very popular, it may be less ambiguous. The link generation module 116 may identify keywords that are in both entities, and then obtain the top queries for each entity. The link generation module 116 may compare the similarity of these queries, and then aggregate the similarity per entity pair using the query weight. The link generation module 116 may then perform an aggregation at the keyword level with the entity popularity.

The link generation module 116 may generate a sum of the scores to determine the overall ambiguous score, which may be used for entity linking.

Sum(Math.Log(1/Similarity)*Popularity)/Sum(Popularity) Equation (6)

For Equation (6), the similarity is between entities, with the logic being that entities which are less similar may be more likely to share an ambiguous keyword. Moreover, if one entity is more ambiguous to a popular entity, then the ambiguous score may be weighted higher. Equations (4), (5) and (6) may be summed together to obtain an ambiguous score. This single combined ambiguous score may be used as an input to the tree model. The output of the tree model may represent the final score which is used to determine linking as disclosed herein.

Referring again to FIG. 1, the feature analysis module 102 may utilize NER to compare a type and score for an entity and a query as features as disclosed herein. For example, a query may be assigned type “LOC” with score 0.9, and then an entity may have type “LOC” with score 0.8. In this regard, the feature analysis module 102 may assign the query 108 and each entity of the entities 114 a type (e.g., a person, a location, an organization, or other), and a score based on a confidence associated with assignment of the type. If the entity and query have the same type, the link generation module 116 may aggregate the scores as a feature for entity linking. For example, the score from the query and entity may be averaged if they have the same type. If the entity and query do not have the same type, a score of zero may be assigned.

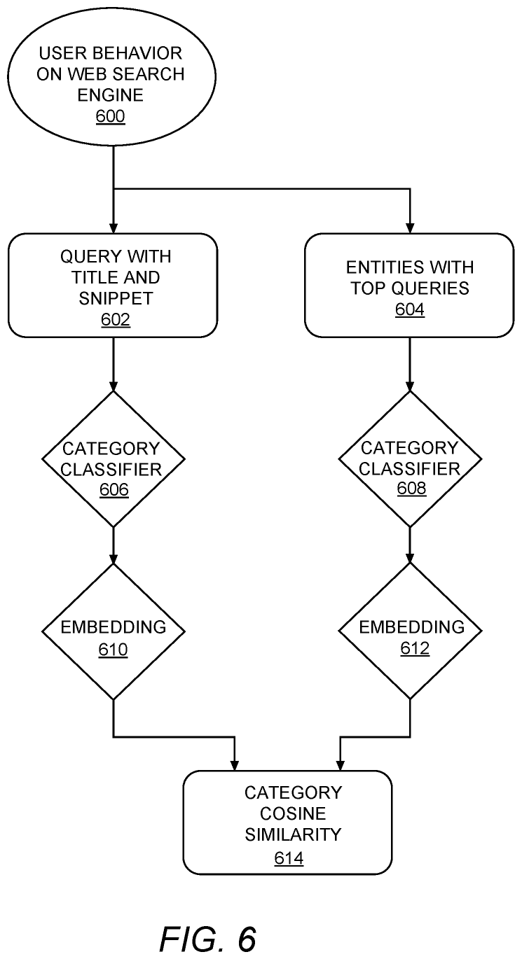

FIG. 6 illustrates a logical flow to illustrate category similarity determination for the apparatus 100 in accordance with an embodiment of the present disclosure.

With reference to FIG. 6, an embedding may represent a vector of numbers representing the semantic understanding of the context (e.g., the query context 106 or the entity context 112). In this regard, the feature analysis module 102 may determine embeddings for the query 108 and for each entity of the reduced number of entities by utilizing, for example, web search engine links, web search engine anchors (e.g., the source and destination of web links), web search engine context (e.g., the title and snippet of web links), and query context (e.g., query, title, and snippet). The link generation module 116 may thus utilize the determined similarity between the query embeddings and the entity embeddings for linking a query to an entity as disclosed herein.

The feature analysis module 102 may define a category for the query 108 and the reduced number of entities as disclosed herein with reference to FIG. 1. In this regard, the feature analysis module 102 may analyze a similarity of a category of the query 108 and the reduced number of entities. In order to determine a category for the query 108 and the reduced number of entities, based on the user behavior at 600 of FIG. 6, the feature analysis module 102 may analyze queries with title and snippet at 602 and entities at 604. The title and snippet may be obtained from documents which are linked to the query, and may depend on user behavior on the web search engine. The feature analysis module 102 may utilize a category classifier at 606 to determine a category for the query 108 at 602. Further, the feature analysis module 102 may utilize a category classifier at 608 to determine a category for each of the entities at 604. At 610 and 612, the feature analysis module 102 may utilize embeddings to determine a similarity at 614 (e.g., a cosine similarity) between the categories associated with the query 108 and the reduced number of entities. The cosine similarity may result in a score between 0 and 1.

The feature analysis module 102 may determine similarity between the query 108 and each entity of the reduced number of entities as a click based similarity. In this regard, as users perform searches on a web search engine, new queries may be obtained. User behavior related to these new queries, that may include searching and clicks, may also be used to update click information (e.g., query, clicked URL, with title and snippet) for existing queries. The click information may be created based on when a user queries on a web search engine, and then clicks on a document (e.g., title, snippet, URL). The feature analysis module 102 may aggregate the counts for how many times a document is clicked for each query. The feature analysis module 102 may determine a query to query similarity, and a URL to URL similarity directly. The query to query similarity may represent a weighted proportion of the intersection of URLs, and the URL to URL similarity may represent a weighted proportion of the intersection of queries. The feature analysis module 102 may determine domain related similarity by first extracting the domain from the URL. One technique of determining domain similarity may include analyzing the similarity between the two domains directly. Another technique of determining domain similarity may include ascertaining URLs for each domain, and determining the aggregate similarity between all URLs for each domain. These similarity scores are all between 0 and 1, and may be used as input as feature vectors to the tree model.

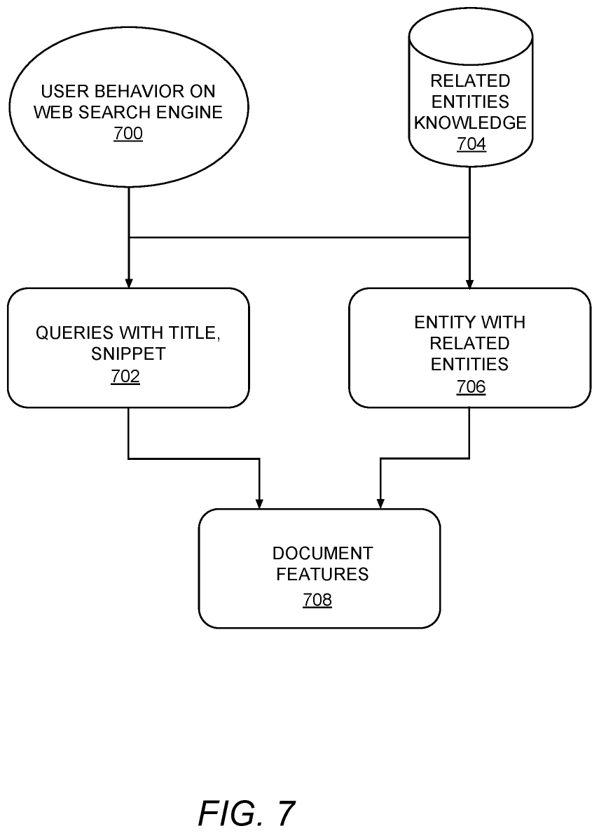

FIG. 7 illustrates a logical flow to illustrate entity repository enrichment for the apparatus 100 in accordance with an embodiment of the present disclosure.

With reference to FIG. 7, as user behavior at 700 may introduce new queries with new titles and snippets, the feature analysis module 102 may aggregate features based on how many times a related entity name or alias appears in the title or snippet of the document from the query. In this regard, the feature analysis module 102 may obtain updated and new queries with the title, snippet at 702, and then compare these new queries with related entities knowledge from 704. The related entities may be competitors and products to companies. The aggregated feature described may be a part of the feature vector input to the tree model.

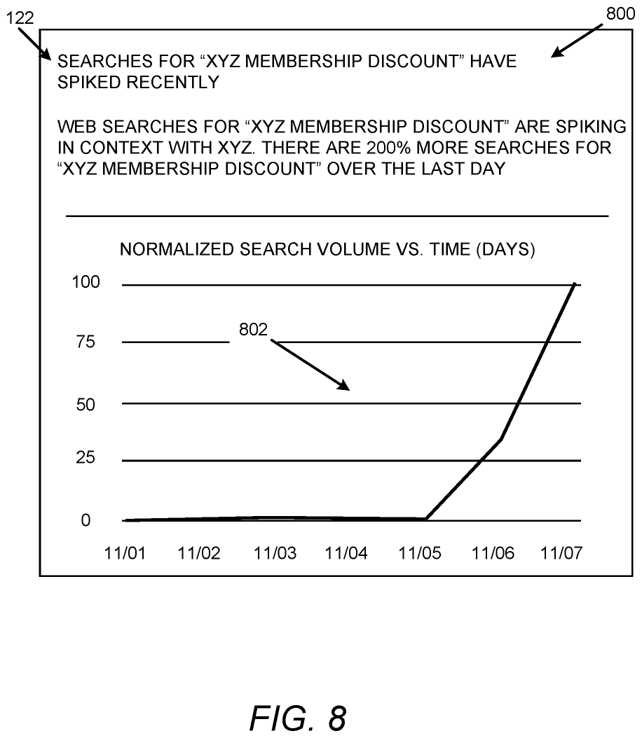

FIG. 8 illustrates an example of search results to illustrate operation of the apparatus 100 in accordance with an embodiment of the present disclosure.

Referring to FIG. 8, as disclosed herein, the search results generation module 122 may generate, based on the search of the linked plurality of queries and entities 126, search results 128 that include the set of queries 130 from a linked plurality of queries that is associated with the selected entity. For example, as shown at 800, the search results 128 may include a general description of queries related to “XYZ membership discount” that are showing an increased trend. In this regard, the search results 128 may include a display of the set of queries 130 from the linked plurality of queries that is associated with the selected entity 124, or a general description of queries associated with the selected entity 124 (e.g., “XYZ” for the example of FIG. 8). The search results 128 may also be displayed in a graph format as shown at 802 in FIG. 8, for example, to show an increase or decrease in the set of queries 130 over a specified time duration.

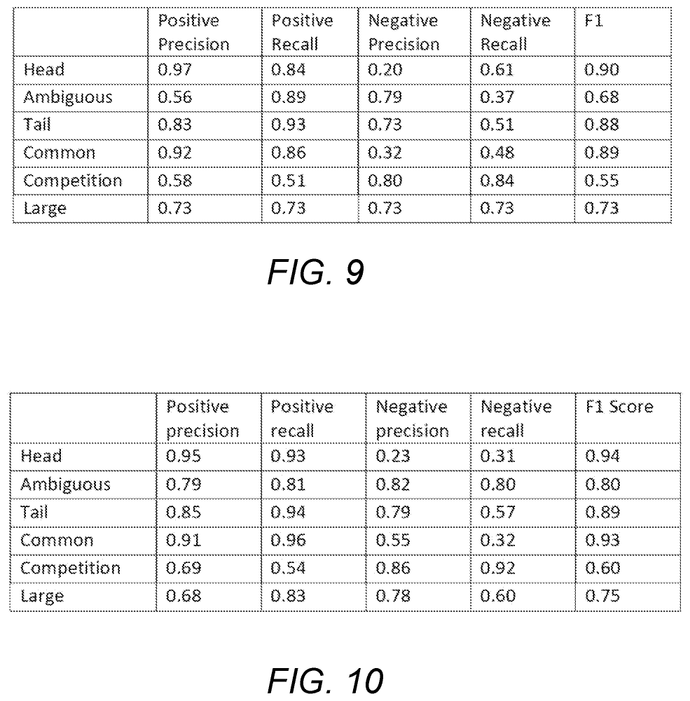

FIGS. 9 and 10 illustrate metrics associated with the apparatus 100 in accordance with an embodiment of the present disclosure.

Referring to FIGS. 9 and 10, the search results 128 generated by the search results generation module 122 include higher accuracy with respect to the set of queries 130 from the linked plurality of queries that is associated with the selected entity 124. For example, FIG. 9 illustrates an F1 score for linking based on an entity and query that have a word in common. For FIGS. 9 and 10, the same set of labeled entity, query pairs are utilized. FIG. 9 provides a positive score if the entity and query have a word in common, while FIG. 10 provides a positive score based on the link generation module 116. For FIG. 10, the entity and query pair may be given a score from the link generation module 116. Then the link generation module 116 may sum the true positives (positive label and positive score), false positives (negative label and positive score), false negatives (positive label and negative score) and true negatives (negative label and negative score). The link generation module 116 may determine precision, recall, and F1, where positive precision is true positive/(true positive +false positives). In this regard, the F1 score for FIG. 10 shows improvements across all categories with respect to identification of the set of queries 130 associated with the selected entity 124.

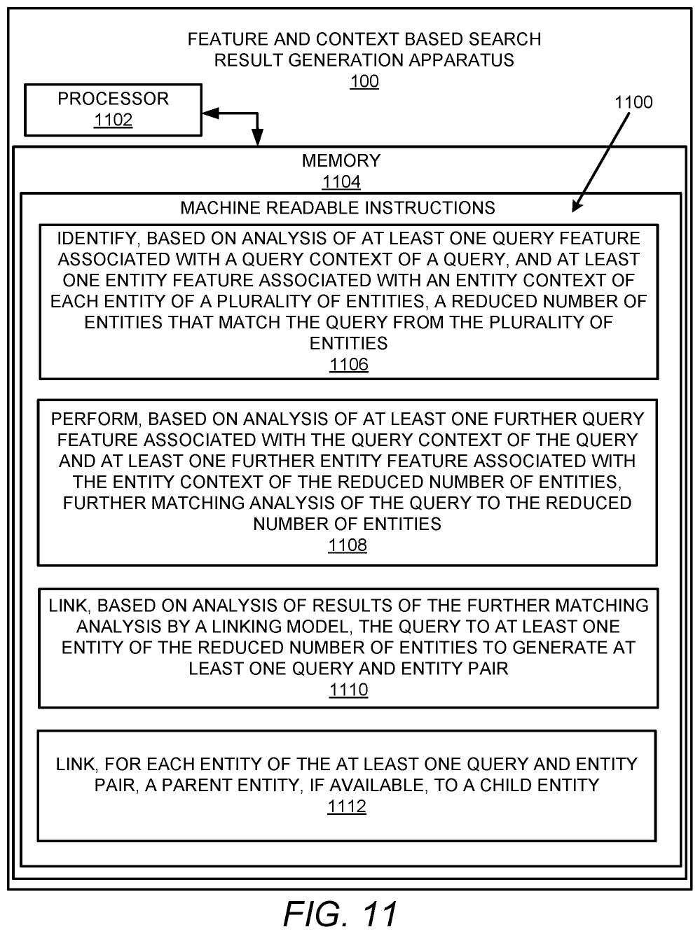

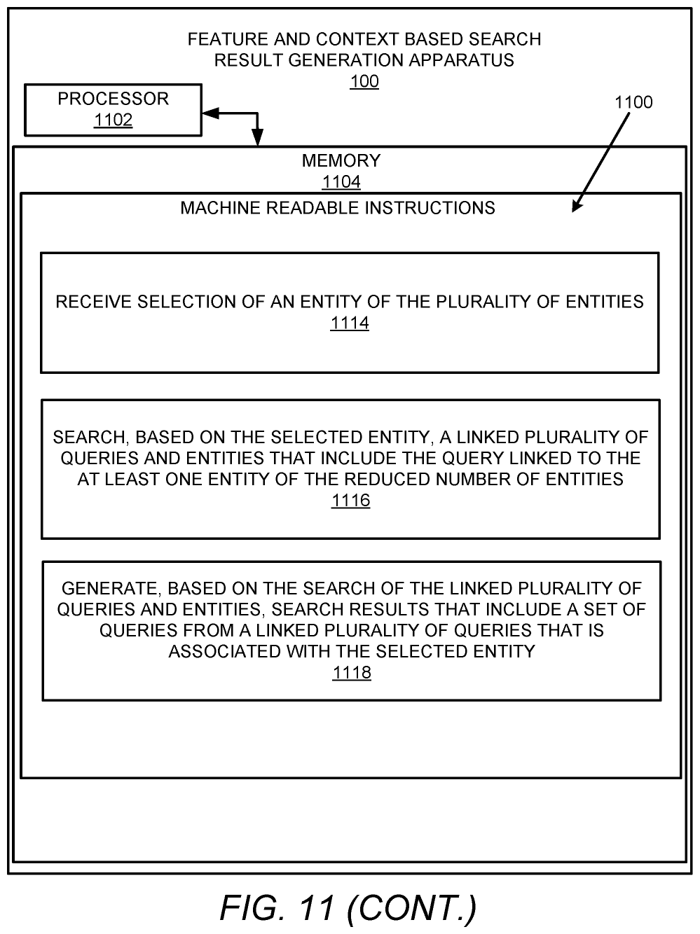

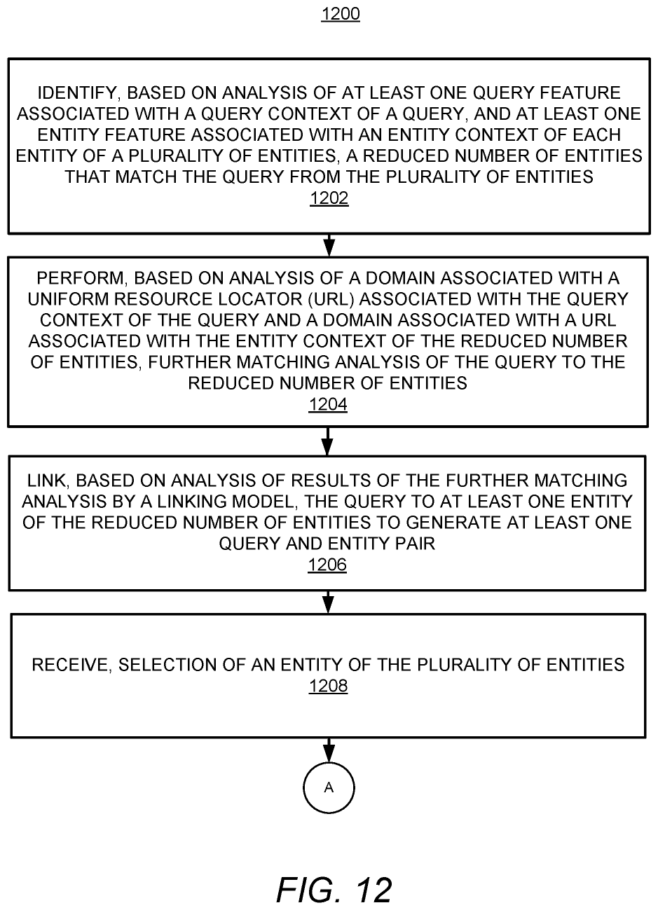

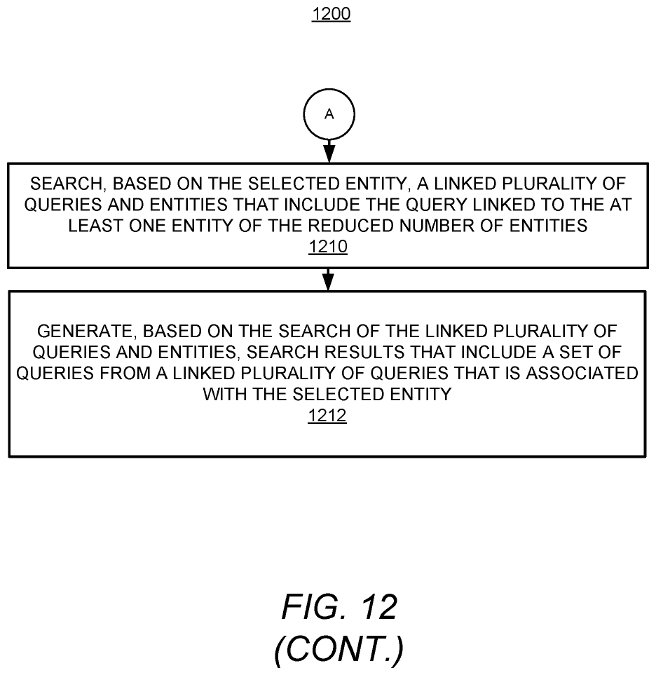

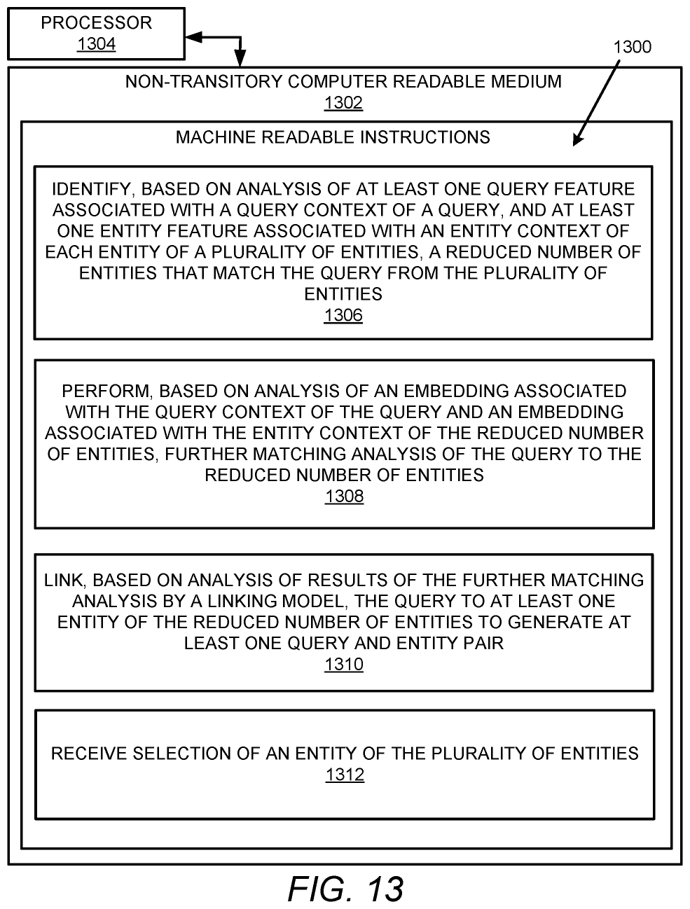

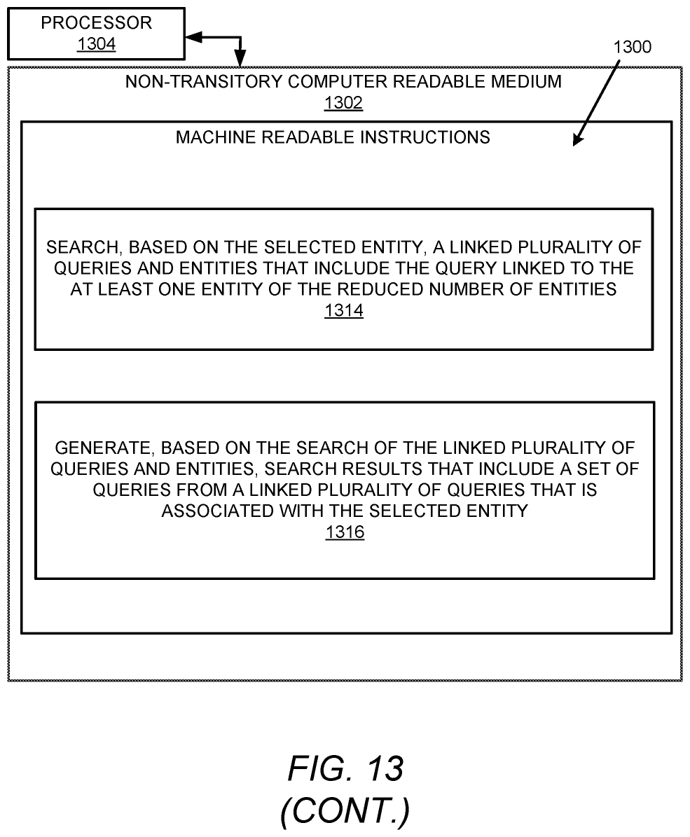

FIGS. 11-13 respectively illustrate an example block diagram 1100, a flowchart of an example method 1200, and a further example block diagram 1300 for feature and context based search result generation, according to examples. The block diagram 1100, the method 1200, and the block diagram 1300 may be implemented on the apparatus 100 described above with reference to FIG. 1 by way of example and not of limitation. The block diagram 1100, the method 1200, and the block diagram 1300 may be practiced in other apparatus. In addition to showing the block diagram 1100, FIG. 11 shows hardware of the apparatus 100 that may execute the instructions of the block diagram 1100. The hardware may include a processor 1102, and a memory 1104 storing machine readable instructions that when executed by the processor cause the processor to perform the instructions of the block diagram 1100. The memory 1104 may represent a non-transitory computer readable medium. FIG. 12 may represent an example method for feature and context based search result generation, and the steps of the method. FIG. 13 may represent a non-transitory computer readable medium 1302 having stored thereon machine readable instructions to provide feature and context based search result generation according to an example. The machine readable instructions, when executed, cause a processor 1304 to perform the instructions of the block diagram 1300 also shown in FIG. 13.

The processor 1102 of FIG. 11 and/or the processor 1304 of FIG. 13 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1302 of FIG. 13), such as hardware storage devices (e.g., RAM (random access memory), ROM (read only memory), EPROM (erasable, programmable ROM), EEPROM (electrically erasable, programmable ROM), hard drives, and flash memory). The memory 1104 may include a RAM, where the machine readable instructions and data for a processor may reside during runtime.

Referring to FIGS. 1-11, and particularly to the block diagram 1100 shown in FIG. 11, the memory 1104 may include instructions 1106 to identify, based on analysis of at least one query feature 104 associated with a query context 106 of a query 108, and at least one entity feature 110 associated with an entity context 112 of each entity of a plurality of entities 114, a reduced number of entities that match the query 108 from the plurality of entities 114.

The processor 1102 may fetch, decode, and execute the instructions 1108 to perform, based on analysis of at least one further query feature associated with the query context 106 of the query 108 and at least one further entity feature associated with the entity context 112 of the reduced number of entities, further matching analysis of the query 108 to the reduced number of entities.

The processor 1102 may fetch, decode, and execute the instructions 1110 to link, based on analysis of results of the further matching analysis by a linking model 118, the query 108 to at least one entity of the reduced number of entities to generate at least one query and entity pair.

The processor 1102 may fetch, decode, and execute the instructions 1112 to link, for each entity of the at least one query and entity pair, a parent entity, if available, to a child entity. In this regard, the link generation module 116 may utilize a global model 120 as disclosed herein.

The processor 1102 may fetch, decode, and execute the instructions 1114 to receive selection of an entity (e.g., the selected entity 124) of the plurality of entities 114.

The processor 1102 may fetch, decode, and execute the instructions 1116 to search, based on the selected entity 124, a linked plurality of queries and entities 126 that include the query linked to the at least one entity of the reduced number of entities.

The processor 1102 may fetch, decode, and execute the instructions 1118 to generate, based on the search of the linked plurality of queries and entities 126, search results 128 that include a set of queries 130 from a linked plurality of queries that is associated with the selected entity. In this regard, according to examples disclosed herein, the search results may include the parent entity, if available, linked to the child entity for each entity of the at least one query and entity pair.

Referring to FIGS. 1-10 and 12, and particularly FIG. 12, for the method 1200, at block 1202, the method may include identifying, based on analysis of at least one query feature 104 associated with a query context 106 of a query 108, and at least one entity feature 110 associated with an entity context 112 of each entity of a plurality of entities 114, a reduced number of entities that match the query 108 from the plurality of entities 114.

At block 1204, the method may include performing, based on analysis of a domain associated with a Uniform Resource Locator (URL) associated with the query context 106 of the query 108 and a domain associated with a URL associated with the entity context 112 of the reduced number of entities, further matching analysis of the query 108 to the reduced number of entities.

At block 1206, the method may include linking, based on analysis of results of the further matching analysis by a linking model 118, the query 108 to at least one entity of the reduced number of entities to generate at least one query and entity pair.

At block 1208, the method may include receiving selection of an entity (e.g., the selected entity 124) of the plurality of entities 114.

At block 1210, the method may include searching, based on the selected entity 124, a linked plurality of queries and entities 126 that include the query linked to the at least one entity of the reduced number of entities.

At block 1212, the method may include generating, based on the search of the linked plurality of queries and entities 126, search results 128 that include a set of queries 130 from a linked plurality of queries that is associated with the selected entity.

Referring to FIGS. 1-10 and 13, and particularly FIG. 13, for the block diagram 1300, the non-transitory computer readable medium 1302 may include instructions 1306 to identify, based on analysis of at least one query feature 104 associated with a query context 106 of a query 108, and at least one entity feature 110 associated with an entity context 112 of each entity of a plurality of entities 114, a reduced number of entities that match the query 108 from the plurality of entities 114.

The processor 1304 may fetch, decode, and execute the instructions 1308 to perform, based on analysis of an embedding associated with the query context 106 of the query 108 and an embedding associated with the entity context 112 of the reduced number of entities, further matching analysis of the query 108 to the reduced number of entities.

The processor 1304 may fetch, decode, and execute the instructions 1310 to link, based on analysis of results of the further matching analysis by a linking model 118, the query 108 to at least one entity of the reduced number of entities to generate at least one query and entity pair.

The processor 1304 may fetch, decode, and execute the instructions 1312 to receive selection of an entity (e.g., the selected entity 124) of the plurality of entities 114.

The processor 1304 may fetch, decode, and execute the instructions 1314 to search, based on the selected entity 124, a linked plurality of queries and entities 126 that include the query linked to the at least one entity of the reduced number of entities.

The processor 1304 may fetch, decode, and execute the instructions 1316 to generate, based on the search of the linked plurality of queries and entities 126, search results 128 that include a set of queries 130 from a linked plurality of queries that is associated with the selected entity.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a computer readable medium on which is stored machine readable instructions that cause the processor to:
identify, based on analysis of at least one query feature associated with a query context of a query, and at least one entity feature associated with an entity context of each entity of a plurality of entities, a reduced number of entities that match the query from the plurality of entities;
perform, based on analysis of at least one further query feature associated with the query context of the query and at least one further entity feature associated with the entity context of the reduced number of entities, further matching analysis of the query to the reduced number of entities;
link, based on analysis of results of the further matching analysis by a linking model, the query to at least one entity of the reduced number of entities to generate at least one query and entity pair;
link, for each entity of the at least one query and entity pair, a parent entity, if available, to a child entity;
receive selection of an entity of the plurality of entities;
search, based on the selected entity, a linked plurality of queries and entities that include the query linked to the at least one entity of the reduced number of entities; and
generate, based on the search of the linked plurality of queries and entities, search results that include a set of queries from a linked plurality of queries that is associated with the selected entity, wherein the search results include the parent entity, if available, linked to the child entity for each entity of the at least one query and entity pair.

2. The apparatus according to claim 1, wherein the set of queries includes a specified number of queries that are associated with the selected entity.

3. The apparatus according to claim 1, wherein the at least one query feature associated with the query context of the query includes at least one keyword included in the query, and the at least one entity feature associated with the entity context of each entity of the plurality of entities includes at least one keyword associated with each entity of the plurality of entities.

4. The apparatus according to claim 3, wherein the instructions further cause the processor to:
specify, based on analysis by a rule, inclusion, with respect to each entity of the plurality of entities, of the at least one keyword associated with each entity of the plurality of entities based on utilization of the at least one keyword associated with each entity of the plurality of entities in queries associated with each entity of the plurality of entities.

5. The apparatus according to claim 1, wherein the at least one further query feature associated with the query context of the query includes a domain associated with a Uniform Resource Locator (URL) associated with the query, and the at least one further entity feature associated with the entity context of the reduced number of entities includes a domain associated with a URL associated with the reduced number of entities.

6. The apparatus according to claim 1, wherein the at least one further query feature associated with the query context of the query includes an embedding associated with the query, and the at least one further entity feature associated with the entity context of the reduced number of entities includes an embedding associated with the reduced number of entities.

7. The apparatus according to claim 1, wherein the instructions to link, based on analysis of results of the further matching analysis by the linking model, the query to at least one entity of the reduced number of entities to generate the at least one query and entity pair further cause the processor to:
analyze, based on the analysis of the results of the further matching analysis by the linking model that includes a tree model, the query with respect to the reduced number of entities; and
generate, based on the analysis of the query with respect to the reduced number of entities, an indication of linking of the query to an entity of the reduced number of entities, or an indication of non-linking of the query to the entity of the reduced number of entities.

8. The apparatus according to claim 7, wherein the instructions to generate, based on the analysis of the query with respect to the reduced number of entities, the indication of linking of the query to the entity of the reduced number of entities, or the indication of non-linking of the query to the entity of the reduced number of entities further cause the processor to:
determine, based on the tree model, a score for each query and entity pair of the at least one query and entity pair;
based on a determination that the score is greater than or equal to a specified threshold, generate, for an associated query and entity pair, the indication of linking of the query to the entity of the reduced number of entities; and
based on a determination that the score is less than the specified threshold, generate, for the associated query and entity pair, the indication of non-linking of the query to the entity of the reduced number of entities.

9. The apparatus according to claim 7, wherein the instructions to generate, based on the analysis of the query with respect to the reduced number of entities, the indication of linking of the query to the entity of the reduced number of entities, or the indication of non-linking of the query to the entity of the reduced number of entities further cause the processor to:
determine, based on the tree model, a score for each query and entity pair of the at least one query and entity pair; and
modify, for each query and entity pair of the at least one query and entity pair, the score based on an ambiguity score of the entity of an associated query and entity pair.

10. The apparatus according to claim 7, wherein the instructions to generate, based on the analysis of the query with respect to the reduced number of entities, the indication of linking of the query to the entity of the reduced number of entities, or the indication of non-linking of the query to the entity of the reduced number of entities further cause the processor to:
identify, for the tree model, a rule to analyze each query and entity pair of the at least one query and entity pair;
generate, based on the identified rule for each query and entity pair of the at least one query and entity pair, a score for each query and entity pair of the at least one query and entity pair.

11. The apparatus according to claim 7, wherein the instructions further cause the processor to:
determine, for each query and entity pair of the at least one query and entity pair, whether a clicked Uniform Resource Locator (URL) for the query includes entities that are not similar to the entity of the associated query and entity pair;
based on a determination, for each query and entity pair of the at least one query and entity pair, that the clicked URL for the query includes entities that are not similar to the entity of the associated query and entity pair, generate an indication of a negative label for the entity of the associated query and entity pair;
based on a determination, for each query and entity pair of the at least one query and entity pair, that the clicked URL for the query includes the entity of the associated query and entity pair, generate an indication of a positive label for the entity of the associated query and entity pair; and
utilize, based on the tree model and for each query and entity pair of the at least one query and entity pair, the negative label or the positive label for the entity of the associated query and entity pair, to determine a score for each query and entity pair of the at least one query and entity pair.

12. A computer-implemented method comprising:
identifying, by at least one processor, based on analysis of at least one query feature associated with a query context of a query, and at least one entity feature associated with an entity context of each entity of a plurality of entities, a reduced number of entities that match the query from the plurality of entities;
performing, by the at least one processor, based on analysis of a domain associated with a Uniform Resource Locator (URL) associated with the query context of the query and a domain associated with a URL associated with the entity context of the reduced number of entities, further matching analysis of the query to the reduced number of entities;
linking, by the at least one processor, based on analysis of results of the further matching analysis by a linking model, the query to at least one entity of the reduced number of entities to generate at least one query and entity pair;
receiving, by the at least one processor, selection of an entity of the plurality of entities;
searching, by the at least one processor, based on the selected entity, a linked plurality of queries and entities that include the query linked to the at least one entity of the reduced number of entities; and
generating, by the at least one processor, based on the search of the linked plurality of queries and entities, search results that include a set of queries from a linked plurality of queries that is associated with the selected entity.

13. The computer-implemented method according to claim 12, wherein the at least one query feature associated with the query context of the query includes at least one keyword included in the query, and the at least one entity feature associated with the entity context of each entity of the plurality of entities includes at least one keyword associated with each entity of the plurality of entities.

14. The computer-implemented method according to claim 13, further comprising:
specifying, based on analysis by a rule, inclusion, with respect to each entity of the plurality of entities, of the at least one keyword based on utilization of the at least one keyword in queries associated with each entity of the plurality of entities.

15. The computer-implemented method according to claim 12, wherein linking, by the at least one processor, based on analysis of results of the further matching analysis by the linking model, the query to at least one entity of the reduced number of entities to generate the at least one query and entity pair further comprises:
analyzing, by the at least one processor, based on the analysis of the results of the further matching analysis by the linking model that includes a tree model, the query with respect to the reduced number of entities; and
generating, by the at least one processor, based on the analysis of the query with respect to the reduced number of entities, an indication of linking of the query to an entity of the reduced number of entities, or an indication of non-linking of the query to the entity of the reduced number of entities.

16. A non-transitory computer readable medium on which is stored machine readable instructions that when executed by a processor, cause the processor to:
identify, based on analysis of at least one query feature associated with a query context of a query, and at least one entity feature associated with an entity context of each entity of a plurality of entities, a reduced number of entities that match the query from the plurality of entities;
perform, based on analysis of an embedding associated with the query context of the query and an embedding associated with the entity context of the reduced number of entities, further matching analysis of the query to the reduced number of entities;
link, based on analysis of results of the further matching analysis by a linking model, the query to at least one entity of the reduced number of entities to generate at least one query and entity pair;
receive selection of an entity of the plurality of entities;
search, based on the selected entity, a linked plurality of queries and entities that include the query linked to the at least one entity of the reduced number of entities; and
generate, based on the search of the linked plurality of queries and entities, search results that include a set of queries from a linked plurality of queries that is associated with the selected entity.

17. The non-transitory computer readable medium according to claim 16, wherein the instructions to link, based on analysis of results of the further matching analysis by the linking model, the query to at least one entity of the reduced number of entities to generate the at least one query and entity pair further cause the processor to:
analyze, based on the analysis of the results of the further matching analysis by the linking model that includes a tree model, the query with respect to the reduced number of entities; and
generate, based on the analysis of the query with respect to the reduced number of entities, an indication of linking of the query to an entity of the reduced number of entities, or an indication of non-linking of the query to the entity of the reduced number of entities.

18. The non-transitory computer readable medium according to claim 17, wherein the instructions to generate, based on the analysis of the query with respect to the reduced number of entities, the indication of linking of the query to the entity of the reduced number of entities, or the indication of non-linking of the query to the entity of the reduced number of entities further cause the processor to:
determine, based on the tree model, a score for each query and entity pair of the at least one query and entity pair;
based on a determination that the score is greater than or equal to a specified threshold, generate, for an associated query and entity pair, the indication of linking of the query to the entity of the reduced number of entities; and
based on a determination that the score is less than the specified threshold, generate, for the associated query and entity pair, the indication of non-linking of the query to the entity of the reduced number of entities.

19. The non-transitory computer readable medium according to claim 17, wherein the instructions to generate, based on the analysis of the query with respect to the reduced number of entities, the indication of linking of the query to the entity of the reduced number of entities, or the indication of non-linking of the query to the entity of the reduced number of entities further cause the processor to:
determine, based on the tree model, a score for each query and entity pair of the at least one query and entity pair; and
modify, for each query and entity pair of the at least one query and entity pair, the score based on an ambiguity score of the entity of an associated query and entity pair.

20. The non-transitory computer readable medium according to claim 17, wherein the instructions to generate, based on the analysis of the query with respect to the reduced number of entities, the indication of linking of the query to the entity of the reduced number of entities, or the indication of non-linking of the query to the entity of the reduced number of entities further cause the processor to:
determine, for each query and entity pair of the at least one query and entity pair, whether a clicked Uniform Resource Locator (URL) for the query includes entities that are not similar to the entity of the associated query and entity pair;
based on a determination, for each query and entity pair of the at least one query and entity pair, that the clicked URL for the query includes entities that are not similar to the entity of the associated query and entity pair, generate an indication of a negative label for the entity of the associated query and entity pair;
based on a determination, for each query and entity pair of the at least one query and entity pair, that the clicked URL for the query includes the entity of the associated query and entity pair, generate an indication of a positive label for the entity of the associated query and entity pair; and
utilize, based on the tree model and for each query and entity pair of the at least one query and entity pair, the negative label or the positive label for the entity of the associated query and entity pair, to determine a score for each query and entity pair of the at least one query and entity pair.
